(19) United States
(12) Patent Application Publication
(10) Pub. No.: US 2003/0205000 A1
(43) Pub. Date: Nov. 6, 2003

(54) Electric door operator

(76) Inventor: Stefan Pagowski, Glen Ellyn, IL (US)

Correspondence Address: JAMES RAY & ASSOCIATES, 2640 Pitcairn Road, Monroeville, PA, 15146, US

(21) Appl. No.: 10/136,164

(22) Filed: May 1, 2002

(51) Int. Cl. E05F 11/24

(52) U.S. Cl. 49/341

(57) ABSTRACT

An electric door operator is provided for controlling the opening and closing of a door pivotally mounted to a door frame of a multi-passenger mass transit vehicle. The electric door operator comprises a pinion and an energy source for rotating or driving this pinion in opposite directions through opening and closing cycles of the door. A gear sector is also provided which is mounted for rotation in an opposite direction from the pinion. The gear sector is engageable with the pinion and capable of being driven by the pinion such that it rotates in one of an opening and closing direction upon rotation of the pinion. A shaft member having a first and second end is provided. The first end of the shaft member is secured to the gear sector and the second end of the shaft member is engageable with one of a base plate and a wall portion of the vehicle. A push bar is suspended from the gear sector for one of opening and closing the door upon rotation of the gear sector in one of the opening and closing directions.

### CROSS-REFERENCES TO RELATED APPLICATIONS

The present application is closely related to U.S. application Ser. No.______ , entitled “Emergency Release Mechanism For An Electrical Bus Door Operator”, filed on ______.

### FIELD OF THE INVENTION

This invention relates generally to power operators for multi-passenger mass transit vehicles, more particularly to an electrically driven rotary door operator for opening and closing dual leaf swing doors such as used in multiple passenger vehicles including airport utility transports, school, and small transit buses.

### BACKGROUND OF THE INVENTION

Prior to the use of power operated door openers, doors of mass transit vehicles were manually opened and closed, typically by the vehicle operator. The strain of actuating these door openings and closings often led to long term medical difficulties for the vehicle operators. The need for power operated door openers led to the development of largely pneumatically actuated operators since in most large vehicles, use of air brake systems provides a reliable and convenient source of operating air at controlled pressures. U.S. Pat. Nos. 4,490,941 and 4,134,231 show examples of pneumatic powered door operators. However, these types of vehicles typically incorporate hydraulic brake systems. Therefore, no air supply is available, and hydraulic door drives are high in cost and involve excessive maintenance in order to prevent leaks and loss of brake system integrity. A growing need for a reliable low cost electric bus door operator now exists.

A power door operator for multi-passenger mass transit vehicles is disclosed in U.S. Pat. No. 5,332,279, the specification of which is hereby incorporated by reference. This type of prior art system incorporates an electrically driven gear motor operating drive arms rotating approximately 160° in order to open and close a dual panel swing door set. A gear motor drive shaft operating through a sleeve clutch operates individually adjustable length drive arms of a drive bar in order to effect approximately 90° rotation of each door from open to closed and closed to open. The operating door shafts located at the outer edges of each panel have door arms affixed thereto for connection to the above-mentioned reciprocating drive arms through door drive rods. Each door drive rod end is interfaced between its respective drive arm and door arm with a spherical rod end.

### SUMMARY OF THE INVENTION

The present invention is directed to an electric rotary door operator for controlling the opening and closing of a door pivotally mounted to a door frame of a multi-passenger mass transit vehicle. The electric door operator comprises a pinion and a means for rotating or driving this pinion in opposite directions through opening and closing cycles of the door. A gear sector is also provided which is mounted for rotation in an opposite direction from the pinion. The gear sector is engageable with the pinion and capable of being driven by the pinion such that it rotates in one of an opening and closing direction upon rotation of the pinion. A shaft member having a first and second end is provided. The first end of the shaft member is secured to the gear sector and the second end of the shaft member is engageable with one of a base plate and a wall portion of the vehicle. A push bar is suspended from the gear sector for one of opening and closing the door upon rotation of the gear sector in one of the opening and closing directions.

### OBJECTS OF THE INVENTION

It is a primary object of the invention to provide an electric rotary door operator for opening and closing at least one door of a mass transit vehicle.

It is another object of the invention to design an operator which may be fully removed from the vehicle to facilitate maintenance and/or replacement thereof.

It is another object of the invention to provide an electric rotary door operator which requires minimal maintenance and is economically produced.

It is yet another object of the invention to produce an electric door operator which is capable of carrying a much higher force than in existing models without the necessity of mechanical force balancing via using two pushing bars acting in opposite directions.

It is still another object of the invention to provide an electric door operator which has a stiffer structure which is necessary for proper meshing between the driving pinion and the driven sector.

It is further object of the invention to provide an electric door operator which is slimmer than existing pneumatic door operators.

In addition to the objects and advantages listed above, various other objects and advantages of the latch door operator disclosed herein will become more readily apparent to persons skilled in the relevant art from a reading of the detailed description section of this document.

### BRIEF DESCRIPTION OF THE DRAWINGS

FIG. 1 shows a perspective view of the electric door operator of the invention.

FIG. 2 shows a cross-sectional side view of the electric door operator of the invention.

FIGS. 3-5 show the electric door operator system of the invention mounted on a door frame.

FIGS. 6-10 show the electric door operator system from several different angles showing the various components involved in the mechanism.

FIG. 11 shows a top view of the gear sector.

FIG. 12 shows an exploded partial side view of the connecting rod secured to the gear sector as shown in FIG. 10.

FIG. 13 shows a front view of the electric door operator of the invention.

FIGS. 14A-14C show the electric door operator of the invention mounted above a door of a vehicle in sequential stages of the door opening operation.

### DETAILED DESCRIPTION OF THE INVENTION

The following background information is provided to assist the reader to understand the environment in which the invention will typically be used. The terms used herein are not intended to be limited to any particular narrow interpretation unless specifically stated otherwise in this document.

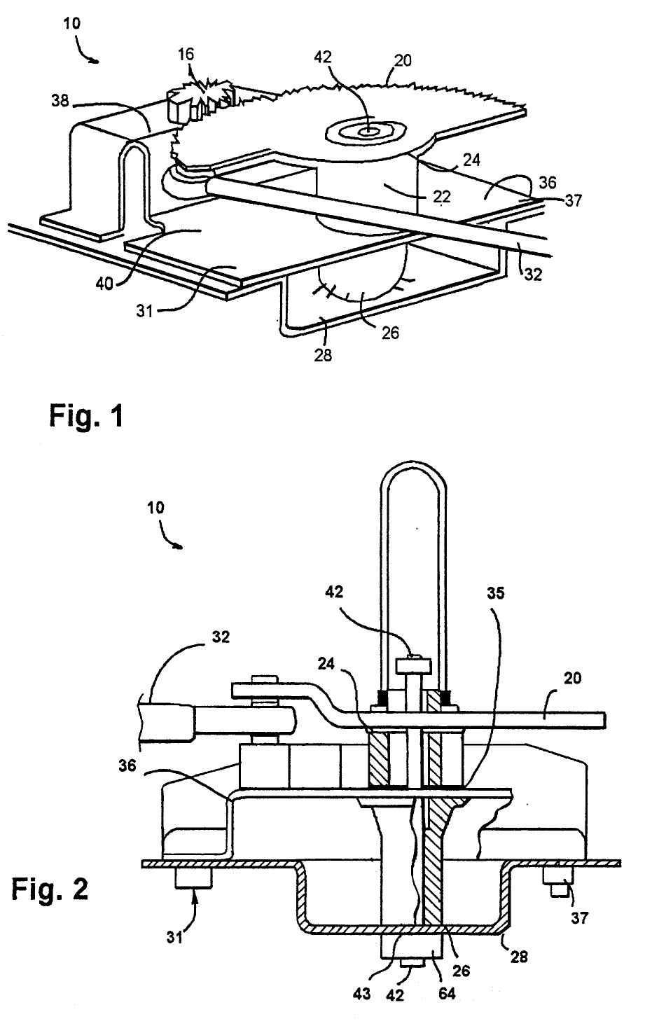

Referring now to FIGS. 1-2, 13 and 14A-14C, there is shown the electric door operator, generally indicated as 10, for controlling the opening and closing of a door, 12 pivotally mounted to a door frame 14 of a multi-passenger mass transit vehicle. The inventive door operator comprises a pinion 16 and a means, such as a gear motor, 18 for rotating or driving this pinion 16 in opposite directions through opening and closing cycles of the door 12. A gear sector 20 is also provided which is mounted for rotation in an opposite direction from the pinion 16. The gear sector 20 is engageable with the pinion 16 and capable of being driven by the pinion 16 such that it rotates in one of an opening and closing direction upon rotation of the pinion 16. A shaft member 18 having a first 24 and second 26 end is provided. The first end 24 of the shaft member 22 is secured to the gear sector 20 and the second end 26 of the shaft member 22 is engageable with one of a base plate 28 and/or a wall portion 30 of the vehicle. The base plate 28 may be a separate plate member of which the shaft member 22 is engageable with and which is consequently secured to the wall 20 of the vehicle. Alternatively, the shaft member 22 may be engageable directly with the wall 30 of the vehicle. A push bar 32 is suspended from the gear sector 20 for one of opening and closing the door 12 upon rotation of the gear sector 20 in one of the opening and closing directions.

The leverage of the mechanism and the ratio between the pinion 16 and gear sector 20 allows the use of maximum torque and maximum current within the gear motor 18 as a signal switching of the driving motor

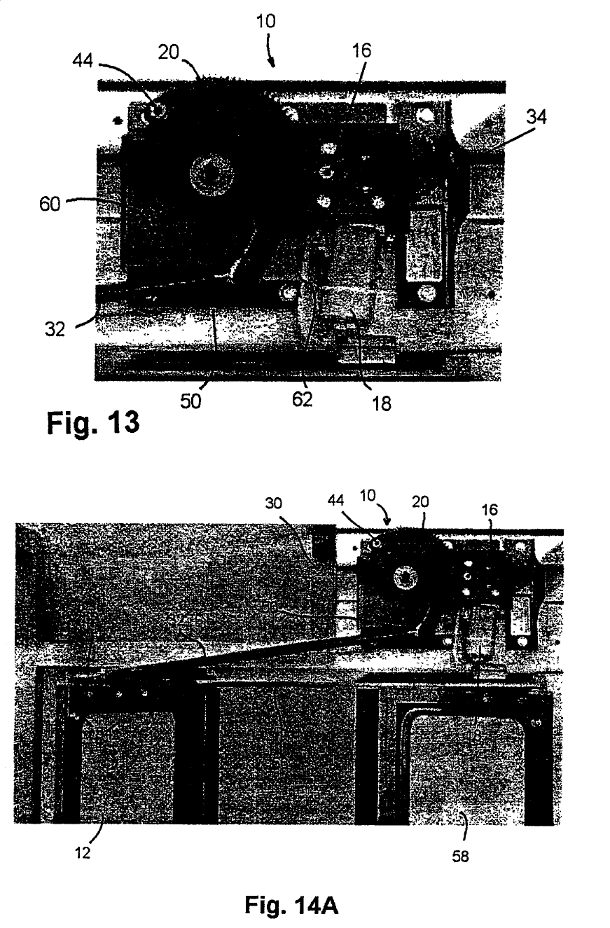

In an emergency situation and/or in the case of electrical failure, the pinion 16 is capable of being disengaged from the gear sector 20 to enable manual opening of the door 12. Disengagement of the pinion can be achieved by means of a handle 34, as shown in FIG. 13. The Figure shows this handle 34 being capable of moving the pinion in a vertical direction. However, the door operator may be modified so that the handle 34 is capable of moving the pinion in a horizontal direction to achieve disengagement of the pinion 16 from the gear motor 18.

A support plate 36 is mounted between the gear sector 20 and one of the base plate 28 and the wall portion 30 of the vehicle. Screws/nuts 37 are also provided along the perimeter of the support plate 36 for securing the support plate 36 to the base plate 28 and/or the vehicle wall 30. The support 36 is formed as an integral part, such as from one piece of a sheet metal, such that a flat portion 38 is close to the pinion 16 and another flat portion 40 supports the shaft member 22 such that under the gear sector 20 there is created a space having a predetermined size for the positioning of the push bar 32 therein.

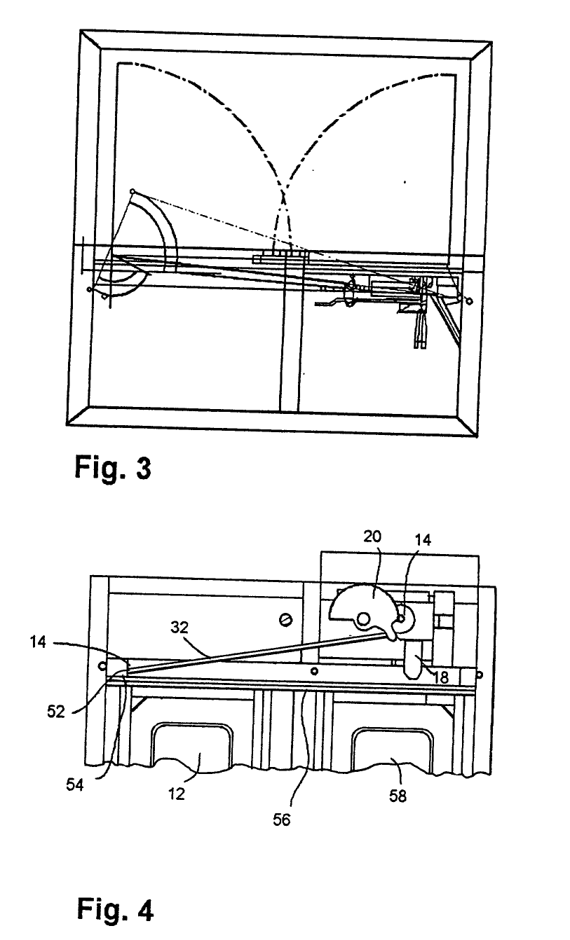

The shaft member 22 is rigidly secured, as generally indicated by 35 in FIG. 2, to the support plate 36. Any well known means can be used for securing the shaft member 22 to the support plate 36 such as welding, brazing, and the like.

A connecting means, such as a screw 42, is provided which extends through the shaft member 22 to threadedly engage one of the base plate 18 and/or wall portion of the vehicle 20. Consequently, the second end 26 of the shaft member 22 is threadedly engageable as shown at 43 with one of the base plate 28 and/or the wall portion 30 of the vehicle. This threaded engagement by the shaft member 22 enables complete removal of the door operator from the vehicle for maintenance and/or replacement. A nut 64 is provided at the bottom of the base 28, 30 for attachment to the screw 42 extending out there from.

This particular design wherein the shaft member 22 of the gear sector 20 is rigidly connected to the support plate 36 and is threadedly connected to the base plate 28 and/or vehicle wall 30 allows for bending action from the shaft member 22 to be transferred into two shearing forces within the base plate 28,30 and the support plate 36. This particular design also reinforces the support of the door opening and vice-versa, resulting in a much stiffer system which is capable of carrying high forces along the push bar 32 without high stresses/fatigue and strains in the support plate 36 or the base plate 28,30.

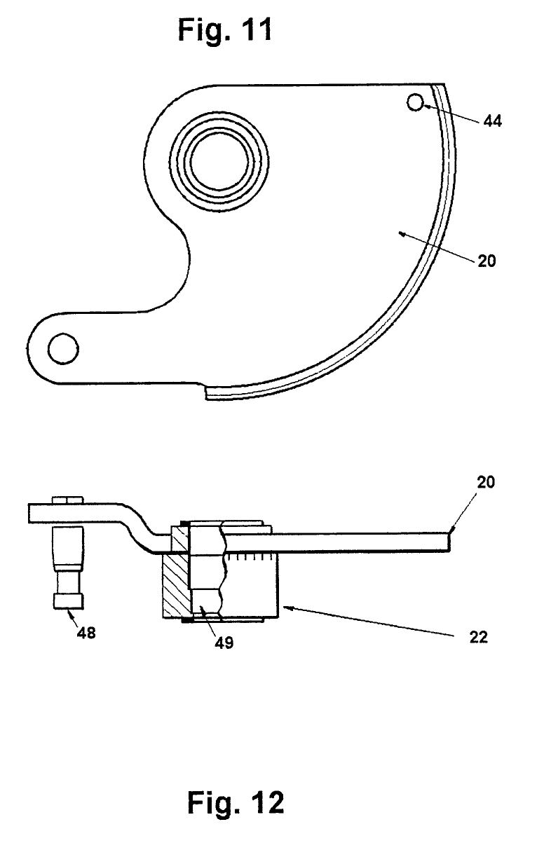

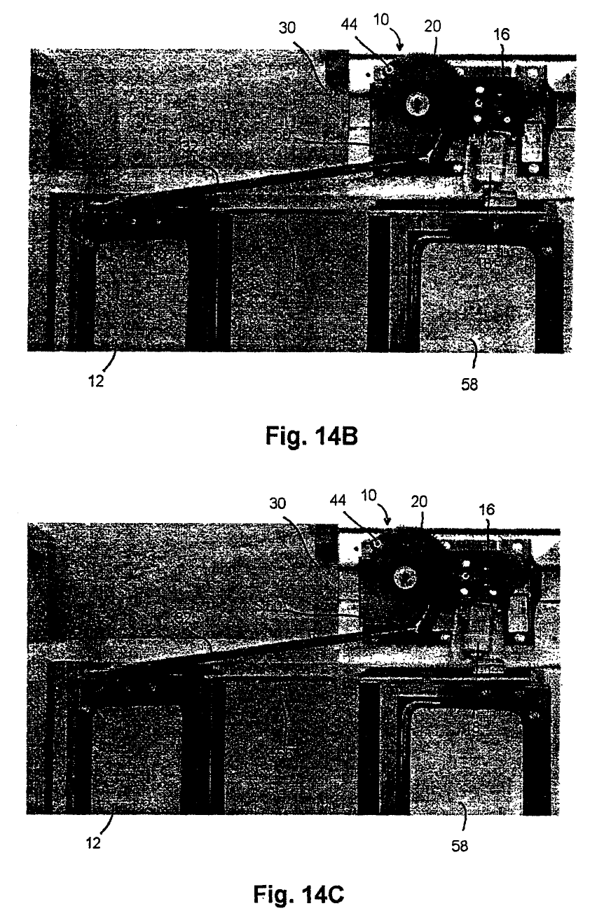

FIG. 12 shows an exploded partial side view of the push bar 32 secured to the gear sector 20 as shown in FIG. 10. The push bar 32 is secured to the gear sector 20 by means of a pin 48. Bearings and bushings 49 are also provided as needed. The push bar 32 has a first end 50 which is suspended from the gear sector 20 and a second end 52 which is connected to brackets 54 mounted on the door frame 14, see FIGS. 14A-14C. A connecting means 56 is secured to a second door 58 for one of opening and closing this second 58 door upon movement of the push bar 32. This connection means 56 can comprise any well known means such as a rod, cable, and the like.

The push bar 32 is suspended from the gear sector 20 as close as possible in order to minimize bending action within the shaft member 22 supporting the gear sector 20.

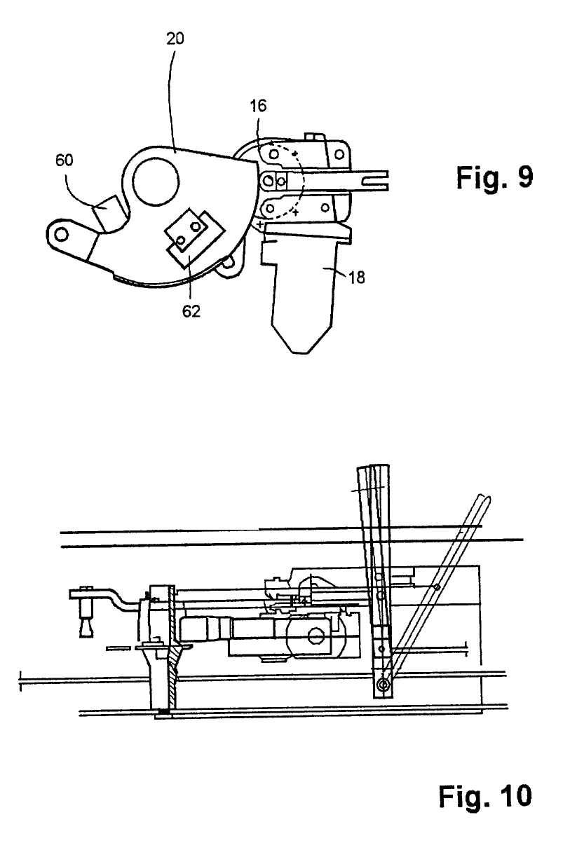

FIG. 11 shows a top view of the gear sector 20 wherein a stop member 44 is provided for halting the motion of the gear sector 20. This prevents movement of the push bar 32 over a “dead line”. This stop means 44 cooperates with at least one limit switch 60, as shown in FIG. 13, for transmitting a signal to the gear motor 18. A second limit switch 62 may also be provided to transmit a signal to the gear motor 18. The limit switches send signals to the gear motor 18 that the opening and/or closing operation of the door 12 is complete and that the direction of the motor should be changed so that the pinion 16 rotates in an opposite direction.

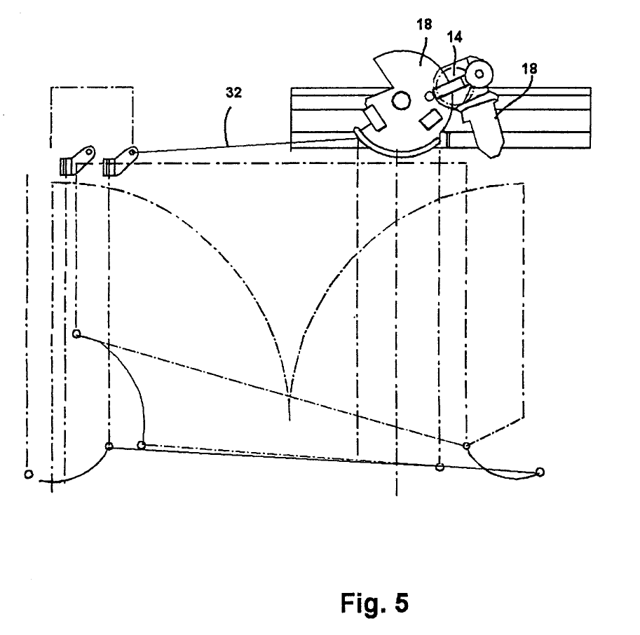

FIGS. 3-5 show the operator system 10 of the invention mounted on a door system. As illustrated in FIG. 4, in order to make it possible to open the door 12 by pushing its panel, eccentric “e” has to be positive. If not, then the emergency release would be useless.

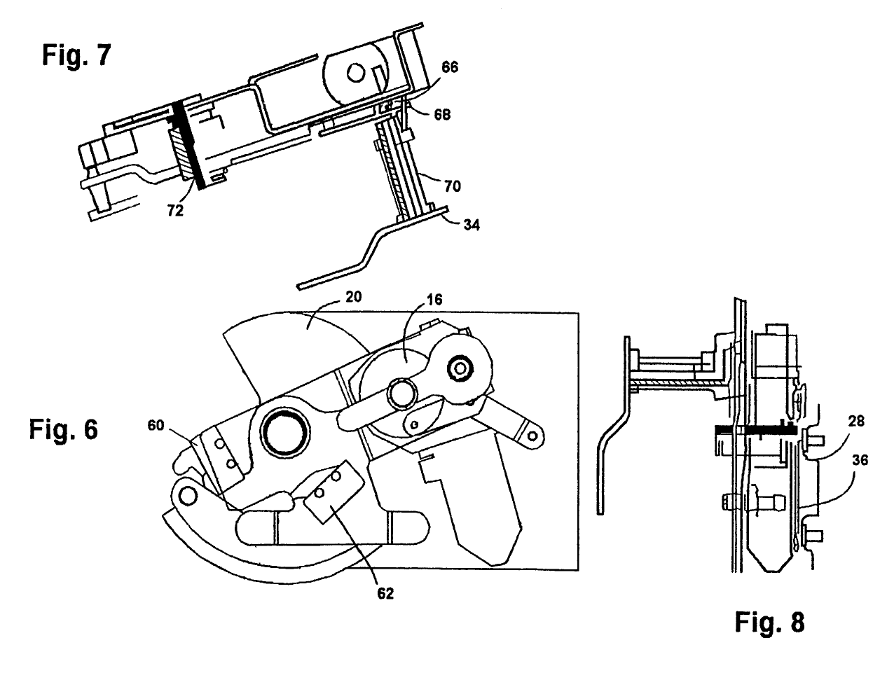

FIGS. 6-10 show the operator system from several different angles showing the various components involved in the mechanism. FIG. 7 shows a spring 66, an actuator 68, and a nut handle 70 which cooperate with handle 34. A collar is also shown at 72.

With respect to the electrical aspects of the inventive operator 10, when the motor is started, the full voltage is switched on. This results in a high current occurring before the door starts moving. A thermal protection is provided to help the control system to distinguish between a high motor current at the start of the stroke of the door and a high motor current at the end of the stroke. During the start time, the spike time is on the range of a couple of milliseconds, at the end of the motion, the time is in the range of hundreds of milliseconds which causes a heating effect which is capable of energizing a bi-metal switch.

It is noted that the Figures show the door operator in connection with a pair of pivotally mounted swing doors. However, one having ordinary skill in the art would recognize that the door operator of the invention may be used to open a single plug door.

The invention has been described in such full, clear, concise and exact terms so as to enable any person skilled in the art to which it pertains to make and use the same. It should be understood that variations, modifications, equivalents and substitutions for components of the specifically described embodiments of the invention may be made by those skilled in the art without departing from the spirit and scope of the invention as set forth in the appended claims. Persons who possess such skill will also recognize that the foregoing description is merely illustrative and not intended to limit any of the ensuing claims to any particular narrow interpretation.

We claim:

1. An electric door operator for controlling the opening and closing of a door pivotally mounted to a door frame of a multi-passenger mass transit vehicle, said electric door operator comprising:
(a) a pinion;
(b) a means for rotating said pinion in opposite directions through opening and closing cycles of such door;
(c) a gear sector mounted for rotation in an opposite direction from said pinion, said gear sector being engageable with said pinion and capable of rotating in one of an opening and closing direction upon rotation of said pinion;
(d) a shaft member having a first and second end, said first end of said shaft member secured to said gear sector and said second end of said shaft member being engageable with one of a base plate and a wall portion of such vehicle; and
(e) a push bar suspended from said gear sector for one of opening and closing a door upon rotation of said gear sector in one of said opening and closing directions.

2. An electric door operator as recited in claim 1 wherein said pinion is capable of being disengaged from said gear sector to enable manual opening of such door.

3. An electric door operator as recited in claim 2 further including a handle for moving said pinion in one of a vertical and horizontal direction for disengagement of said pinion with said gear sector.

4. An electric door operator as recited in claim 1 wherein said second end of said shaft member is threadedly engageable with one of said base plate and such wall portion of such vehicle.

5. An electric door operator as recited in claim 1 further including a support plate mounted between said gear sector and said one of said base plate and such wall portion of such vehicle.

6. An electric door operator as recited in claim 5 wherein said shaft member is rigidly secured to said support plate.

7. An electric door operator as recited in claim 6 including a screw member extending through said shaft member to threadedly engage one of said base plate and such wall portion of such vehicle.

8. An electric door operator as recited in claim 5 wherein a space having a predetermined size is provided between said gear sector and said support plate.

9. An electric door operator as recited in claim 8 wherein said push bar is positioned within said space.

10. An electric door operator as recited in claim 1 further including a stop member for limiting the rotation of said gear sector.

11. An electric door operator as recited in claim 1 wherein said means for rotating said pinion comprises a gear motor.

12. An electric door operator as recited in claim 11 further including at least one limit switch for transmitting a signal to said gear motor.

13. An electric door operator as recited in claim 1 wherein said push bar has a first end which is susp ended from said gear sector and a second end which is connected to brackets mounted on such door frame.

14. An electric door operator as recited in claim 13 further including a connecting means secured to a second door for one of opening and closing such second door upon movement of said push bar.

15. An electric door operator as recited in claim 14 wherein said connecting means comprises one of a rod and a cable.
